(19) United States
(12) Patent Application Publication
(10) Pub. No.: US 2008/0135117 A1
(43) Pub. Date: Jun. 12, 2008

(54) Dispenser Tap

(75) Inventors: Guy Robert Hansson, Essex (GB); Paul Clifford Smith, Hertfordshire (GB); John Justin Walshe, Wiltshire (GB)

Correspondence Address: BROOKS KUSHMAN P.C., 1000 TOWN CENTER, TWENTY-SECOND FLOOR, SOUTHFIELD, MI, 48075, US

(73) Assignee: DIAGEO IRELAND, Dublin (IE)

(21) Appl. No.: 11/571,474

(22) PCT Filed: Jun. 30, 2005
(86) PCT No.: PCT/GB05/02599

§ 371 Date: Aug. 20, 2007

(30) Foreign Application Priority Data
Jul. 2, 2004 (GB) 0414938.1

(51) Int. Cl. B67D 1/14; B65D 83/00; B67D 5/06

(52) U.S. Cl. 137/600; 222/395; 222/328

(57) ABSTRACT

A dispenser for delivering beverages (e.g. beer) including a main body (20), an inlet (21), an outlet (23) and a piston stop valve (23). In use, the piston moves from a first closed position (A) to a second position (B) where fluid is permitted only through a restricted aperture (31) provided in a collar (27) that extends around the piston. The restricted flow path causes turbulence and hence foam formation on the beverage. In a third position (C), flow is completely open from the inlet to the outlet.

### TECHNICAL FIELD

The present invention relates to a dispenser tap, particularly of the type used in public houses to dispense beer or ale products.

### BACKGROUND ART

FIG. 1 is a sketch of a common prior art dispensing tap that includes a main body 10 with inlet 11 and outlet 12 ports, the liquid flow therethrough being controlled by a piston-like stop valve 13. This kind of valve has been known for many years, usually operated by a pivoting lever and some type of spring loading acting to move the stop valve between a closed A and open B position.

Some beverage products (e.g stout) require the dispenser to include an agitating means to produce a foamy head as the beverage is dispensed. A usual way to achieve this is to use a creamer plate 14 (also known as a restrictor plate) that contains a plurality of fine holes 14a. Stout passes through the holes and gas (e.g nitrogen) is encouraged out of solution to form tiny bubbles that comprise the head on the beverage.

A creamer plate 14 of the known type is simple and effective, however, it has several drawbacks. The main drawback is that over time the small holes 14a can become clogged with scale and other impurities from the beer delivery lines and from beverage that dries inside the dispensing nozzle outlet 12 when not in use.

Ideally, staff at the public house where the tap is installed will regularly clean the nozzle and creamer plate 14 by removal (the creamer plate is normally mounted in a threaded nozzle) and soaking overnight. Despite these relatively simple maintenance requirements, cleaning can be neglected and it is not uncommon for servicemen to be called out to fix a “faulty” dispenser, when all that is wrong is some scale has built-up on the creamer plate.

Attempts have been made in the past to move the position of a conventional creamer plate to the “wet side” of the valve. For example, WO9837011 describes such an arrangement where all beer passing through the tap is agitated before it reaches the outlet valve. This arrangement could be used with stout type beer but would still encounter clogging problems from impurities (it does, however, avoid the problem of dried beer deposits).

Also known to the hospitality trade is a dispenser tap more suitable for lager that does not include a creamer plate (because this would result in a glass full of foam and little or no actual drinkable liquid) in the main flow-line, but includes a secondary flow-line for a small portion of the liquid bound for the glass that does include agitating means. This is simply an aid for the bar staff to deliver an aesthetically pleasing foam head to the lager. This is usually done by filling most of the glass with smoothly flowing liquid and then pressing a button on the tap to activate a brief squirt of agitated liquid through the secondary flow-line that provides a foamy head.

Such devices require some practice to use due to the timing of delivering a desirable head. Similar problems with cleaning of the extra flow channel agitating means can be experienced.

A prior art example that goes some way to providing an improved feature in dispenser taps is GB2225840. This construction includes a spiral groove in the end of the piston valve, with a seal upstream. A sloped side wall in the nozzle bore is such that when the seal lifts, beer flows into the grooves causing agitation until the valve withdraws fully, thereby allowing smooth flow. Careful control of the tap can allow the user to hold the dispenser in an agitated position to provide a foam head as desired.

GB2225840 has similar maintenance problems as described above, i.e the grooved end of the piston is in open air when not in use and thus can dry up and become clogged.

### DISCLOSURE OF THE INVENTION

It is an object of the present invention to provide an improved dispenser tap that goes some way to alleviating the problems experienced in the prior art or at least provide an alternative.

According to one broad aspect the present invention there is provided a dispenser including a main body and a bore at least partially therethrough with an inlet, an outlet and a piston moving therewithin from a first position when, in use, fluid flow between the inlet and the outlet is closed to a second position where fluid flow is open toward the outlet through a restricted aperture provided upstream of the outlet where it was closed in the first position.

In a preferred form of the first broad aspect a third position is provided that allows relatively unrestricted flow between the inlet and the outlet.

A second broad aspect the present invention provides a dispenser including a main body, an inlet, an outlet and a piston therewithin, wherein means capable of permitting a restricted fluid flow path is provided integral with or appended to the piston, said means moving with the piston and being located upstream of a seal means associated with the piston adjacent the outlet.

### BRIEF DESCRIPTION OF DRAWINGS

FIG. 1 is a prior art dispensing tap provided for comparison,

FIG. 2 is an illustration of three-stage operation of a first embodiment of a dispenser tap according to the present invention, in cross section view,

FIG. 3 is an illustration of a second embodiment,

FIG. 4 shows a third embodiment,

FIG. 5 shows a fourth embodiment,

FIG. 6 shows three stage operation of the fourth embodiment from FIG. 5, and

FIG. 7 shows a fifth embodiment.

### MODE(S) FOR CARRYING OUT THE INVENTION

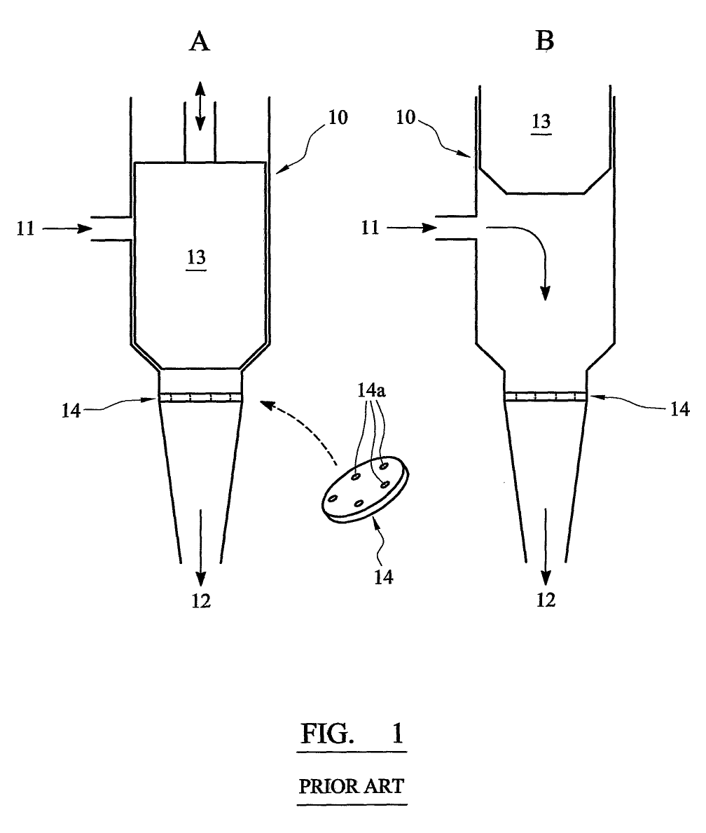

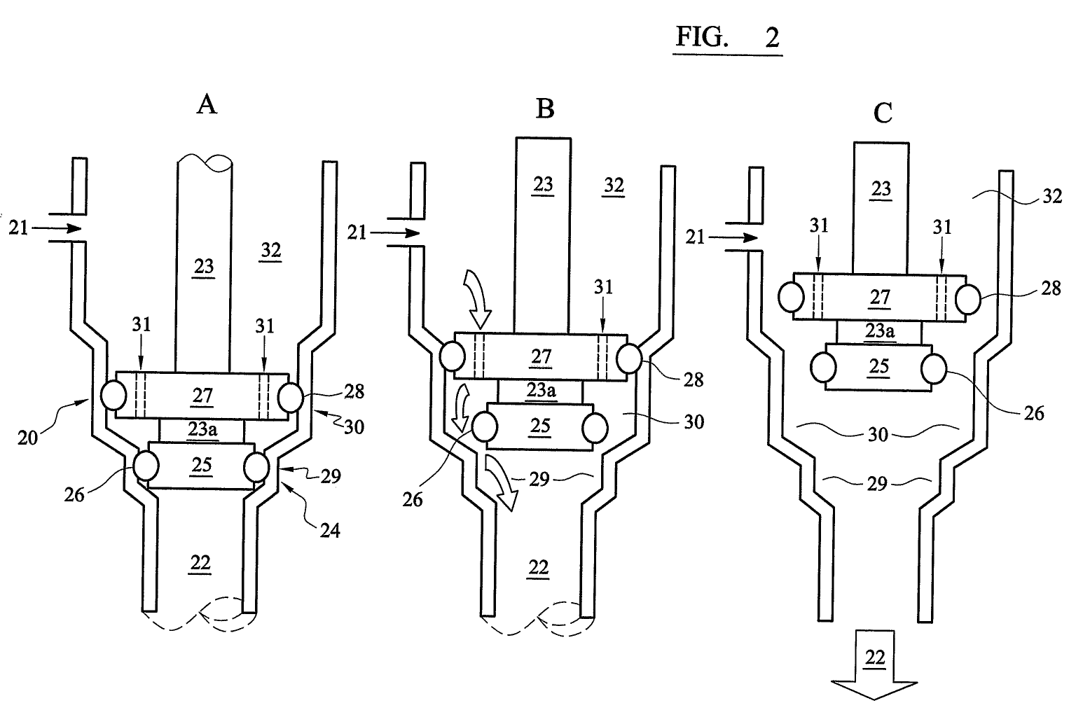

As outlined in the introduction, a prior art dispenser according to FIG. 1 suffers from the drawback that the creamer plate 14 is left open to the air when not in use, meaning liquid can dry and cause clogging. It is also not possible to bypass the creamer plate, making the design unsuitable for some kinds of beverage. The dispenser tap of the present invention according to FIGS. 2 to 7 relies on the creamer plate (or equivalent) being located upstream of the outmost seal at the outlet, i.e. on the “wet-side” of the valve. As such, problems with material drying in the restrictor holes is eliminated or significantly reduced in the course of normal use.

Referring to FIG. 2, a simple form of the invention is shown to illustrate the main concepts. In its three stage operation the invention shown in the drawings will be consistently denoted A (closed) B (intermediate or turbulent flow) and C (fully open flow). The tap construction includes a main body 20 (with a bore therethrough—this bore could be machined or formed in any appropriate way known to the art), an inlet 21, an outlet (nozzle) 22 and a piston stop valve 23. At a distal end of the piston is first seal portion 24. The illustrated form of seal portion 24 is a piston head 25 (conforming within the internal dimensions of the main body 20 adjacent the outlet 22), with an O-ring seal member 26 extending thereround.

At a second position on the piston 23 adjacent but spaced (by a spacer 23a) from the piston head 25 is an annular collar 27 around the piston shaft and extending radially toward the walls of the main body 20. An O-ring seal 28 surrounds collar 27, sandwiched against the side wall to seal therewith (in positions A and B).

It will be apparent from the illustration that the main body 20 of the dispenser includes bore sections at increasing diameters. Not including the outlet 12, there are three diameter “zones” that effectively provide stepped surfaces in the sidewall when viewed in cross section, like FIG. 2. The piston head 25 is machined (cast or moulded) to fit into the first zone 29. In the closed position A head 25 seals the dispenser shut.

Collar 27 is machined to fit within the second zone 30 (larger diameter than zone 29).

Collar 27 is also machined with one or more apertures 31 (shown in dotted detail) therethrough to permit a restricted fluid flow, thus when the piston 23 is withdrawn to an intermediate position B, fluid flows through the apertures 31 toward outlet 22. This is possible by virtue of zone 30 being deeper (e.g. vertically a longer distance) than zone 29. Piston head 25 therefore moves out of zone 29 and opens a path to outlet 22 before collar 27 moves out of zone 30.

In a final (third position) stage C collar 27 moves out of zone 30 to a third zone 32 which has a substantially wider diameter than collar 27. As such fluid can flow freely between the inlet 21 and outlet 22 around any appendages to the piston 23, or at least freely relative to turbulent position B.

The practical effect of the three stage operation is that when the fluid is beer (e.g normal carbonated lager type product), the intermediate stage B delivers mostly foam through the outlet 22 by agitation through apertures 31, until the valve is fully open. Beer flowing through apertures 31 is negligible in position C.

In the reverse operation (to close the valve), the dispenser again passes a stage of turbulent flow (B) before returning to the closed position A.

The apertures 31 in collar 27 are equivalent to the creamer plate 14 of FIG. 1 (prior art). However, because before and after use the apertures are always flooded with fluid, there is no opportunity for dried residue to cause clogging. Furthermore, other debris/scale etc. from the beer lines will generally be washed away by flow over the top surface of collar 27 during the fully open flow stage C.

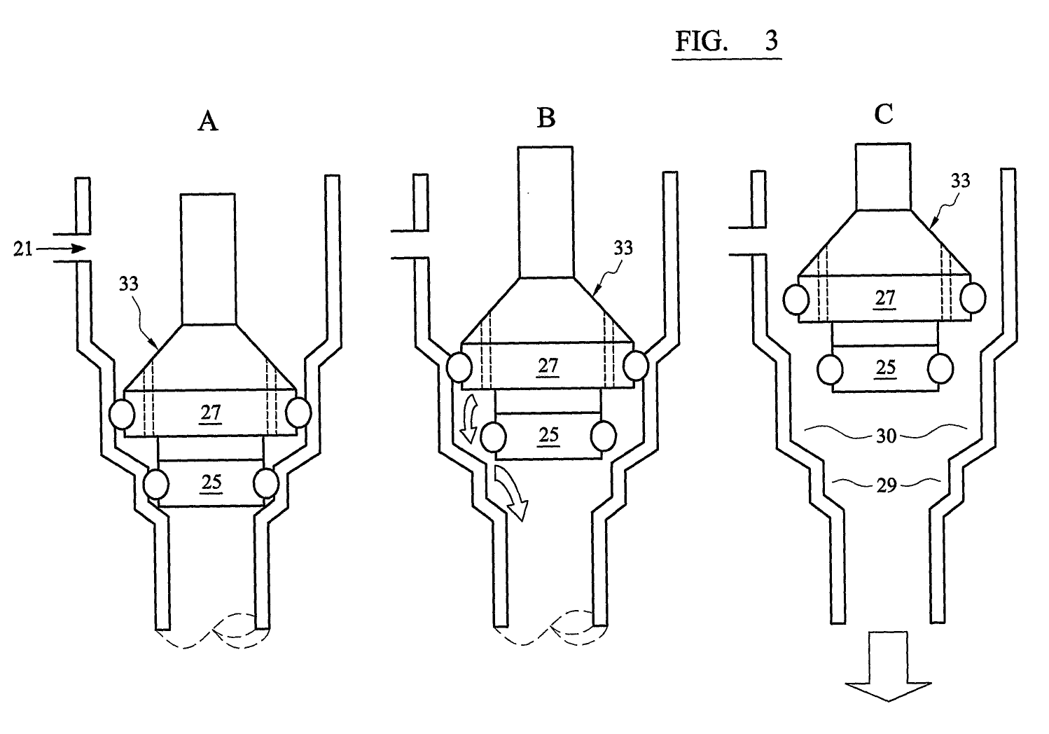

In the event that a small amount of debris could accumulate on the flat upper surface of collar 27, a second embodiment as shown in FIG. 3 includes a downwardly sloped (conical) surface 33 for collar 27. The slope facilitates any debris to “fall off” collar 27 and out of the nozzle 22. Otherwise, the operation between FIGS. 2 and 3 are the same.

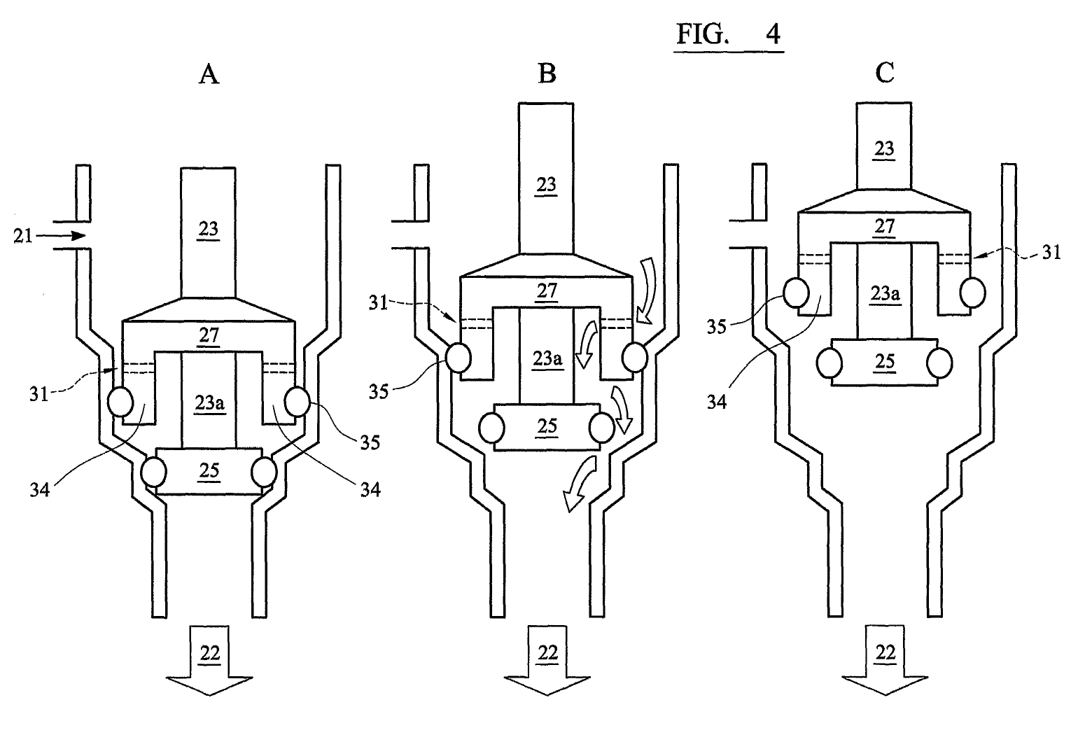

A third embodiment, illustrated by FIG. 4, has collar 27 further modified to include a downwardly projecting annular wall 34 with apertures 31 formed through the sides (horizontally as opposed to vertically in FIGS. 2 and 3) thereof. An O-ring 35 downstream of apertures 31 provides equivalent sealing around wall 34 like the first and second embodiments. In position B fluid flow is horizontal through apertures 31 such that the possibility for debris to build up in the apertures is minimised. In other respects operation is equivalent to the first and second embodiments. Notably, the spacer 23a between piston head 25 and collar 27 should be longer to give adequate clearance for turbulent flow through apertures 31 and past piston head 25.

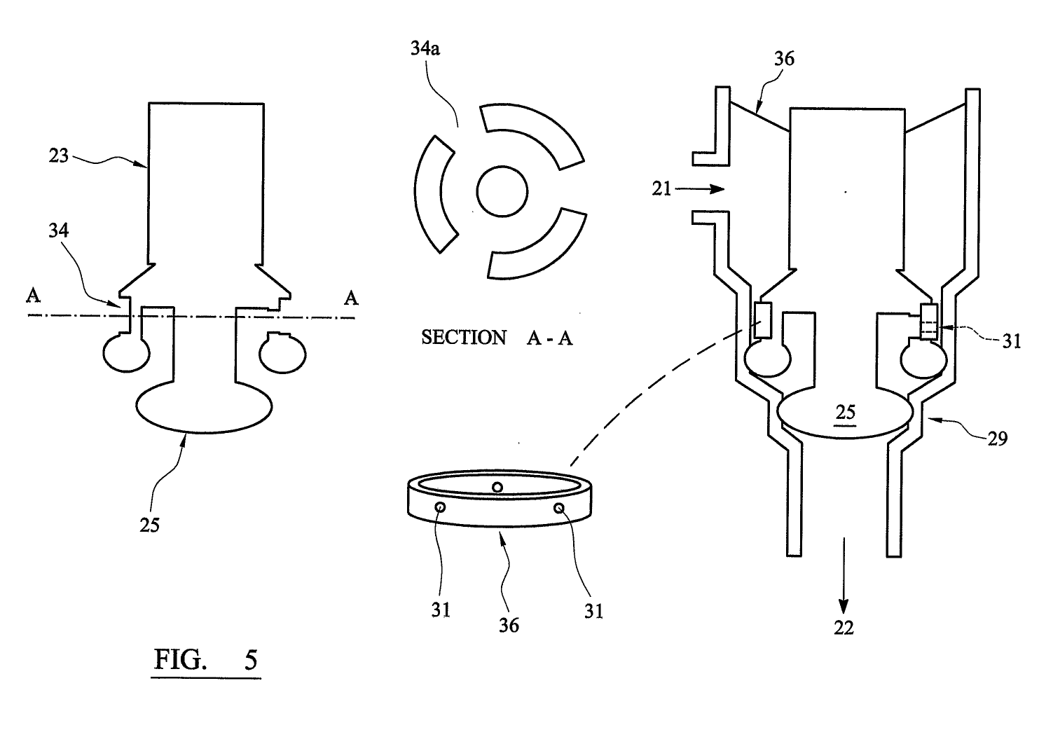

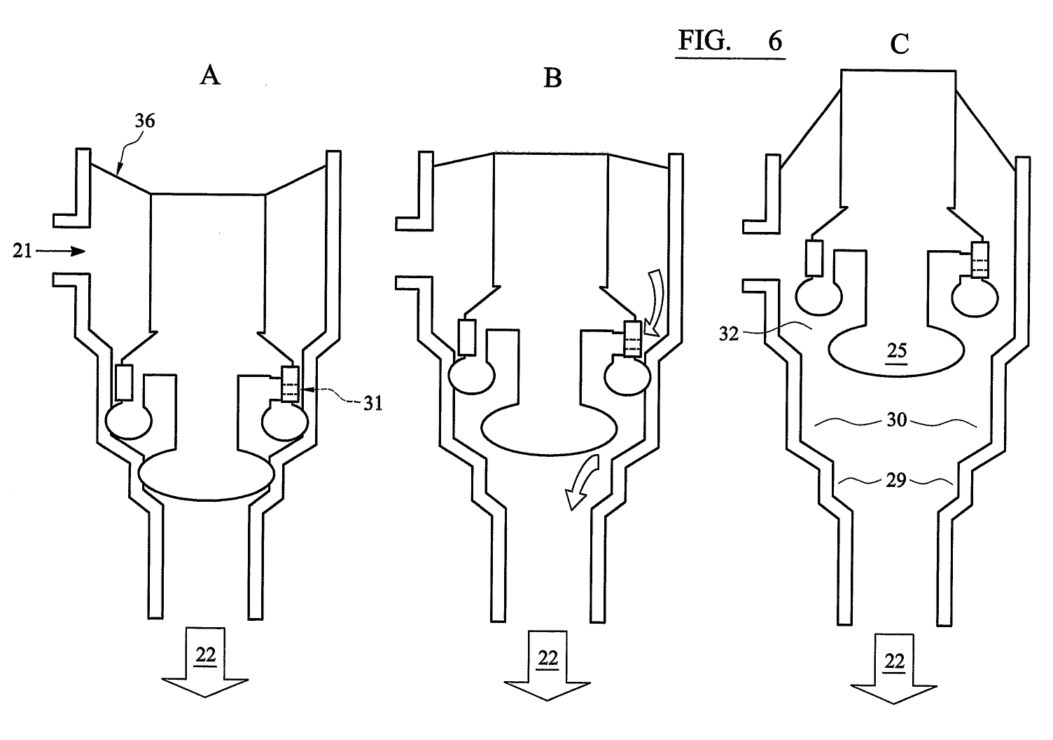

FIGS. 5 and 6 show a fourth embodiment that gives an alternative construction to FIG. 4. Piston 23 is formed of a suitable material (plastic, rubber coated etc.) that includes integral seals instead of separate O-rings. Piston head 25 is a squashed spherical shape to fit into zone 29 in a sealing fit over outlet 22.

A cross section A-A of annular wall 34 shows large apertures 34a moulded therein, such that a metal ring 36 can be forced onto the piston piece, around wall 34. Small apertures 31 align with the larger gaps 34a to permit horizontal flow therethrough, in an equivalent way to FIG. 4. A metal component is preferable so that it provides sharp edges to the apertures that improve turbulence to liquid flowing through. This preference is maintained for all embodiments.

In the illustrated embodiment, the upper end of the piston includes a diaphragm member 36. This prevents liquid flooding the upper parts of the dispenser tap where a lever mechanism would be used to move the piston in the usual way (not illustrated).

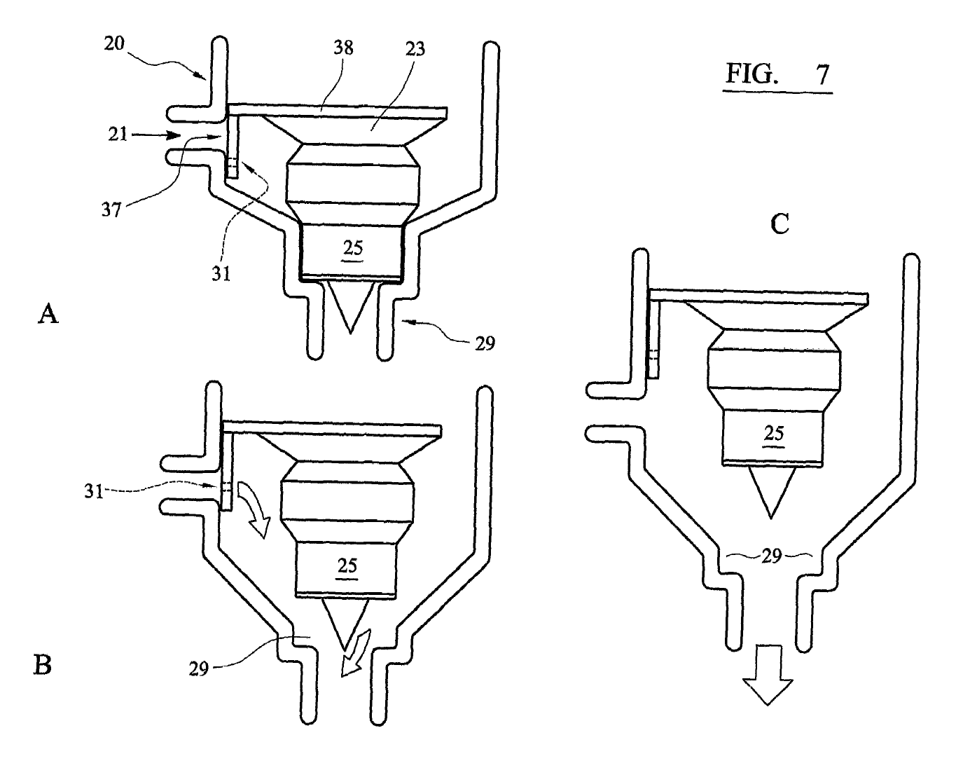

FIG. 7 continues the concept of associating operation of the apertured “creamer” means with movement of the piston. Position A again features a closed valve. Piston head 25 is in place in zone 29 of the stepped main body 20. Furthermore, a second closure means 37 extending from an upper end of the piston 23 covers the inlet port 21. This closure means 37 is merely a closely fitting plate sliding parallel to the wall of the main body chamber and connected for movement by a boom 38 extending from piston 23.

In position B piston head 25 moves out of zone 29 while closure 37 correspondingly moves an aperture 31 formed in the closure plate 37 into alignment with inlet 21. This permits restricted (foam creating) flow while in position B.

When closure 37 moves past inlet 21 completely flow is open in position C. As with the previous embodiments a reverse operation causes turbulent flow at position B before the valve is closed again at position A.

An advantage of this fifth embodiment is that a double sealing function is performed.

The common feature to all embodiments is that movement of the piston dictates when flow can be opened through an associated restricted aperture for at least part of the dispensing operation.

There is no requirement for a separate flow passage providing turbulence features. Dispensing an aesthetically pleasing foamed product can be performed in one operation, with minimal training and maintenance.

The main embodiments are a three-stage operation, however, a two-stage operation with an equivalent apertured collar still falls within the scope of the present invention. For example, the “third zone” 32 (FIG. 2) is not needed when certain stout beers are being dispensed. No “open” flow C is necessary and turbulent flow like that provided by the prior art would be achieved.

Furthermore, the closure plate 37 of FIG. 7 could be extended downwardly to align a large (relatively non-restrictive) aperture with inlet 21 when the dispenser is in stage B and align a second restricted aperture when in position C (normally fully open flow). This reverses the flow profile such that for the longer period of pouring the beverage (position B), the turbulent mode is being used. This is more appropriate for certain stout ale beverages where a creamy, foamy head is desirable.

A simplified embodiment includes use of a sealing “bung” type head to the piston to close the outlet in a first position. A collar as described, with apertures, radially extends from the piston and seals with the bore side wall such that when the bung is withdrawn, the only path is restricted flow through the apertures. However, the piston/collar can then continue to be withdrawn past the location of the inlet 21 at which point open flow is permitted between inlet and outlet. This embodiment retains the advantage of a “wet side” creaming function and does not need a multiple sectioned (stepped) bore.

A further simplified embodiment involves using a stationary shelf-like annular ring with restrictive apertures or cut-outs appended to the bore below the inlet (this could be in the form of an insert placed in the bore during assembly). The piston closes the outlet as usual and then as it withdraws there is turbulent flow through the restricted apertures. If the piston withdraws past the stationary annular ring there will be unrestricted flow down the central hole through which the piston moves.

### INDUSTRIAL APPLICABILITY

The present invention can be manufactured using available techniques and materials. It is probable that a dispenser according to the present invention may be made from a variety of materials, using plastic mouldings where appropriate and also machined stainless steel etc for durable fittings. As already stated it is preferable but not essential that the restrictive portion of the design be made from a hard material like stainless steel as opposed to plastic for a durable sharp edge to be maintained.

1. A dispenser including a main body and a bore at least partially therethrough with an inlet, an outlet and a piston moving therewithin from a first position when, in use, fluid flow between the inlet and the outlet is closed to a second position where fluid flow is open toward the outlet through a restricted aperture provided upstream of the outlet where it was closed in the first position.

2. The dispenser according to claim 1 wherein a third position is provided that allows relatively unrestricted flow between the inlet and the outlet.

3. The dispenser of claim 1 wherein the main body bore includes at least two different diameter sections, the smaller diameter being formed toward the outlet.

4. The dispenser of claim 1 wherein the main body bore includes up to four different diameter sections, said diameters increasing from the outlet side toward the inlet.

5. The dispenser of claim 4 wherein a first diameter section corresponds to an outlet side, a second diameter section corresponds with a piston head seal at a distal end of the piston, a third diameter section corresponds with an apertured collar, wider than the piston head seal, extending about the piston and a fourth diameter section communicates with the inlet.

6. The dispenser of claim 3 wherein a second diameter section is deeper relative to a first diameter section.

7. The dispenser of claim 1 wherein the piston includes a collar extending about the piston, said collar including the restricted aperture.

8. The dispenser of claim 7 wherein the collar includes a sloped upstream surface.

9. The dispenser of claim 7 wherein the collar includes a wall extending downstream, said wall including the restricted apertures.

10. The dispenser of claim 9 wherein a seal means is provided at the downstream wall, downstream of the apertures, to seal with the bore wall in both first and section positions.

11. The dispenser of claim 1 wherein the piston includes a piston head to seal against or toward the outlet in the first position and a member extending from the piston to mount a restricted aperture over the inlet when the piston is moved to the second position.

12. A dispenser including a main body, an inlet, an outlet and a piston, wherein means capable of permitting a restricted fluid flow path is provided integral with or appended to the piston, said means moving with the piston and being located upstream of a seal means associated with the piston adjacent the outlet.

13. The dispenser of claim 12 wherein the means of permitting restricted flow is an annular member extending radially from the piston to a wall of the main body, said annular member including a restrictive aperture or channel.

14. The dispenser of claim 1 including a diaphragm extending radially from the piston to the main body.
